(19) United States
(12) Patent Application Publication
(10) Pub. No.: US 2007/0141268 A1
(43) Pub. Date: Jun. 21, 2007

(54) Composite meterial for printed circuit board applications

(76) Inventor: Damon Brink, Goleta, CA (US)

Correspondence Address: MARK RODGERS, 1590 SAN ROQUE ROAD, SANTA BARBARA, CA, 93105, US

(21) Appl. No.: 11/312,039

(22) Filed: Dec. 19, 2005

(51) Int. Cl. B05D 7/00

(52) U.S. Cl. 427/407.1

(57) ABSTRACT

The invention is a novel process for producing composites, for Printed Circuit Board substrates, which are resistant to Conductive Anodic Filamentation (CAF). The method is based on using a pressurized fluid as a medium to deposit coating layers uniformly and at high density on fiber or particle surfaces, where the fibers and/or particles are components of the composite. These coating layers have functionalized chemical designs that produce CAF resistant properties such as increased fiber-resin bond strength, moisture resistant fiber filaments, and lower thermal expansion coefficient resin.

### RELATED APPLICATIONS

Not Applicable

### FEDERALLY SPONSORED RESEARCH

Not Applicable

### SEQUENCE LISTING

Not Applicable

### BACKGROUND OF THE INVENTION

The invention is directed toward improving composite material used in the fabrication of Printed. Circuit. Boards (PCB's). In particular the improved materials are resistant to Conductive Anodic Filamentation (CAF).

Most PCB's consist of etched metal patterns on a composite substrate (the board). High circuit density applications often are produced of a laminate of a stack of substrates, where the conductive patterns on the various layers connect through inter layer connections, usually in the form of metallized vias. As is known in the art, the composite material used in PCB's is typically a variant of fiberglass. Referring to FIG. 1, the majority of PCB glass consists of a woven mesh of glass fibers 2, embedded in a epoxy resin matrix 1. Such a material can be made with a wide variety of properties depending on the choice of fiber and resin, and such materials are used in myriad applications, covering the range from blast resistant armor to recreational structures such as boats and surfboards

The material properties of PCB composites are chosen for durability, high electrical insulation, low cost, and the ability to withstand the etching and heating inherent in the manufacturing of electronic circuits. This combination of requirements leads to the construction shown in FIG. 1, a glass cloth mesh 1 in an epoxy resin matrix 2. On a fine scale, the mesh consists of interwoven filaments, 3. Typical Glass cloths used in PCB manufacture are shown in Table 1.

TABLE 1
Glass Cloth

106
1080
1500
1652
2113
2116
2165
2313
3070
3313
7628
7629
7635

A recent development in PCB manufacturing is causing concern about the viability of existing PCB composites. A mandate that lead-free solder be used instead of traditional lead based solders will cause the soldering reflow temperature to increase. There is evidence that the higher temperature may affect the interface between the glass fibers and the resin matrix, leading to a reliability problem known as CAF, Conductive Anodic Filamentation. This problem is illustrated in FIG. 2. Thermal and mechanical stresses can lead to separation 6 between fiber 3 and resin matrix 1. If the fiber stretches between two vias 4 and 5 (or other charged PCB structures), that in operation of the PCB are at differing voltages, indicated by + and − in the figure, conditions for CAF may be possible. Interface separation can enable rapid diffusion of water, metal ions, and other contaminates which combine to form a conductive filament 7 along the fiber-resin interface. The growth of the filament is driven by the gradient in potential between different vias, and thus is exacerbated by smaller via spacing. It has been shown that the conductive deposits can build up along the fiber 3 until the two biased structures 4 and 5 are shorted together, leading to circuit failure. Even if no interface separation occurs, remaining moisture and ions in the resin or along the fibers can still lead to CAF.

The inventor believes evidence shows that exposure to increased temperature is a factor in producing the conditions that lead to CAF. This is due, in part, to the thermal expansion difference between the resin and fiber that can lead to separation. Also key are the bond strength between the fiber and the resin, and the rate of water diffusion along the fiber-resin interface. Although treatments to increase bond strength and other potential mitigations have been proposed, the processing difficulties and potential effectiveness of proposed solutions are questionable.

Therefore it is the object of this invention to provide a novel process to make PCB substrate composites, leading to decreased temperature-induced delamination and increased resistance to CAF formation.

### BRIEF SUMMARY OF THE INVENTION

The invention is a process for treating a fiber, or woven fiber mesh, intended to be a component of a resin-fiber composite. The process includes the steps of:
placing the fiber or fiber mesh in a reactor
introducing a first agent into the reactor
pressurizing the reactor
introducing a second coating agent, and any required activating agents, into the reactor, the second agent chosen to be both solvent in the pressurized first agent, and have chemical properties such that when exposed to the fiber surface will form a coating layer on the fiber
leaving the agents and fiber in the reactor under pressurized conditions for a time sufficient to coat the fiber surface with a coating layer of coating agent.
   In one embodiment, the coating agent is constructed to have chemical properties such that the coating layer will create a bond with the resin that increases resin-fiber bond reliability, under exposure to elevated temperatures, in the completed composite. In another embodiment, the coating layer is constructed to have chemical properties such that the coating layer will create a hydrophobic layer on the fiber surface, such that the fiber-resin interface will resist moisture infiltration. In other embodiments, the coating layer will act as an ion getter, or any combination of the ion getter, bond strength improvement or hydrophobic change.

In another embodiment, the invention includes a step of heating the reactor. In a further embodiment, the reactor is pressurized to a pressure ≧860 PSI.

In a preferred embodiment the heating and pressurization levels are set for at least some time period such that the first agent is a supercritical fluid. In one version, the first agent is CO₂, and the pressure is ≧1070 PSI and the temperature is ≧34.5° C. In a further version, the pressure is ≧1500 PSI, and in another version is ≧3000 PSI. In another aspect, operating at 150° C. is advantageous. In another aspect, the coating is a SAM and the coating density is ≧1.5 molecules/nm², and in another ≧4.5 molecules/nm².

In various embodiments, the coating layer may be chosen from the list of Table 2.

In another embodiment, the invention is a process for reducing the effective thermal expansion coefficient of a resin intended to be a component of a resin-fiber composite. The process includes mixing particles in with the resin before making the composite. The particles are chosen to have a lower thermal expansion coefficient of expansion than the resin. In other embodiments, the particles may either have ion getter properties, be hydrophobic, or hydrophilic. Particles with any combination of the above attributes may be used. The particles include compounds chosen from Table 3. The preferred size range is 5 nm to 1 micron.

One embodiment further includes a process for treating the particles including the steps of:
placing the particles in a reactor
introducing a first agent into the reactor
pressurizing the reactor
introducing a second coating agent, and any required activating agents, into the reactor, the second agent chosen to be both solvent in the pressurized first agent, and have chemical properties such that when exposed to the particle surface will form a coating layer on the particle; and,
leaving the agents and particles in the reactor under pressurized conditions for a time sufficient to coat the particles' surface with a dense coating layer of coating agent.
   In one version, the coating agent is constructed to have chemical properties such that the coating layer will either create a bond between the particles and the resin, act as ion getter, be hydrophobic, be hydrophilic, aid in dispersal of the particles when mixed with the resin or any combination of the above properties.

The various embodiments for temperature, pressure and desolving agents as described for the fiber also are applicable to the particles, as are the coating chemisties.

### BRIEF DESCRIPTION OF THE DRAWINGS

The invention will be better understood by referring to the following detailed description and the accompanying figures.

FIG. 1 is an illustration of composite material structure for PCB substrates.

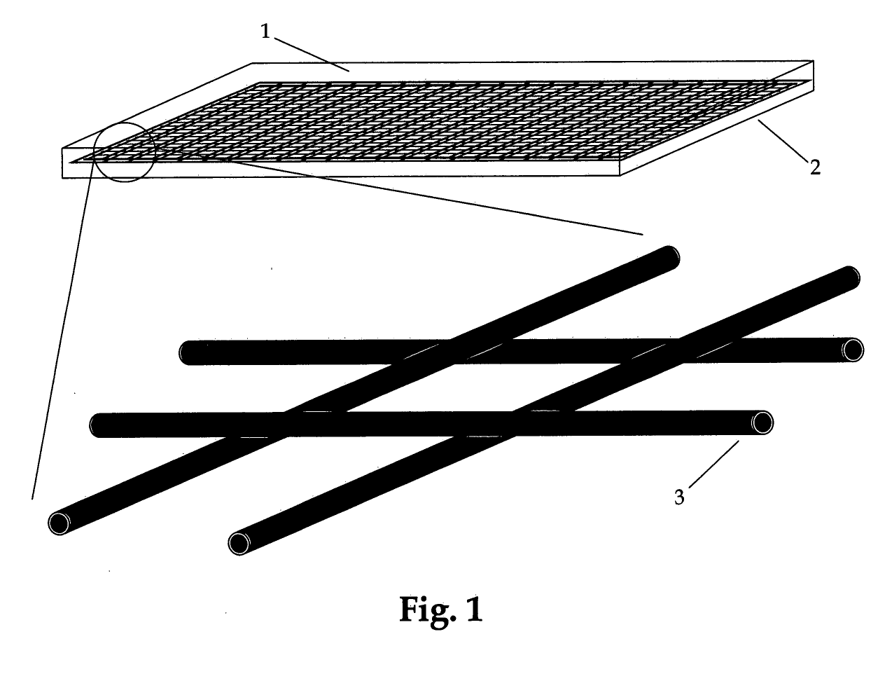

FIG. 2 illustrates the mechanism of CAF.

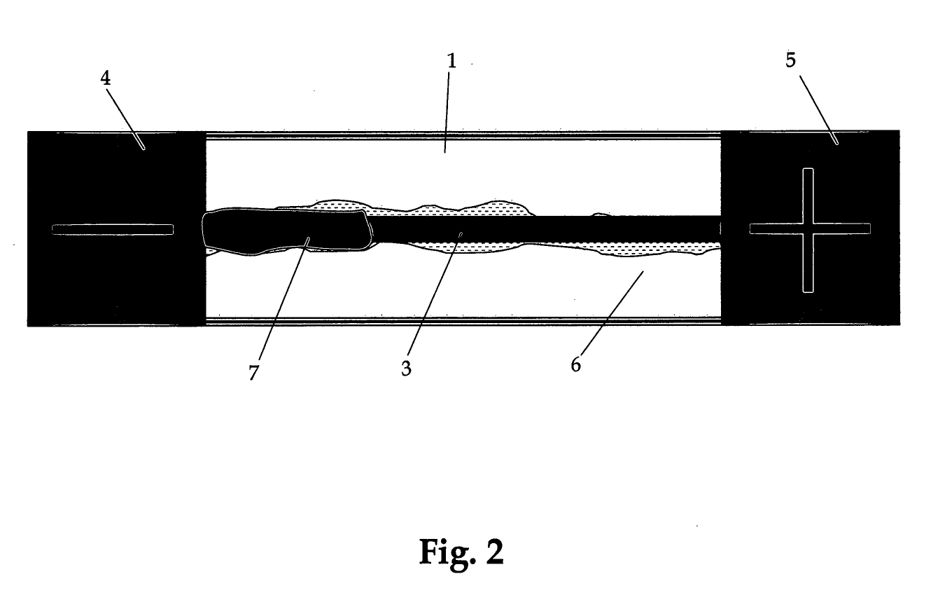

FIG. 3 illustrates the operation of an embodiment of the invention.

FIG. 4 is an exemplary flow diagram of a coating process.

FIG. 5 is an illustration of a further embodiment of the invention

FIG. 6 is an illustration of an aspect of the embodiment of

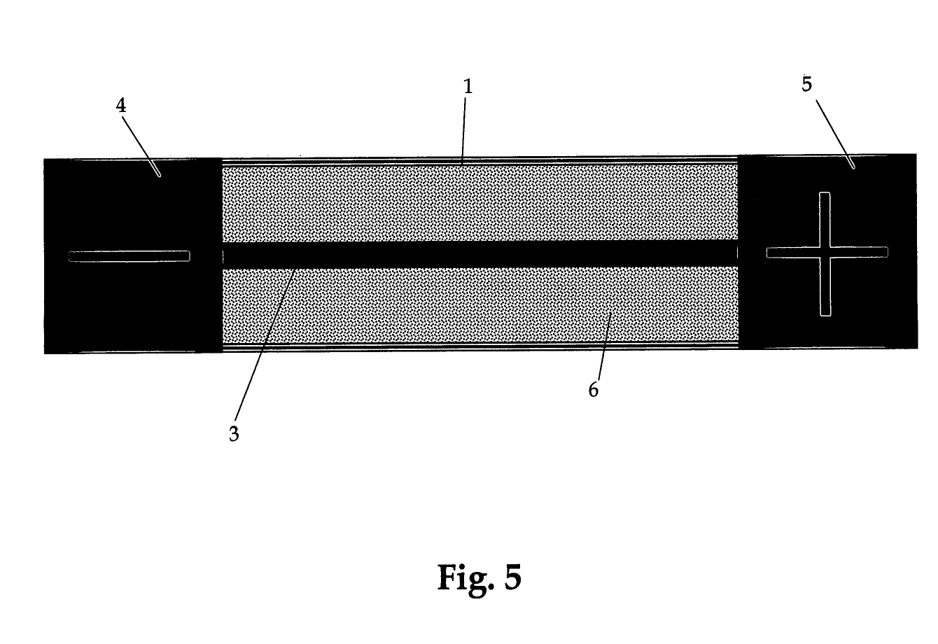

FIG. 5

### DETAILED DESCRIPTION OF THE INVENTION

One aspect of the present invention involves a process for creating coatings that allow for composites with improved resistance to CAF, by forming a coating on the fiber surfaces. This coating may be a self-assembled monolayer in the ideal scenario, but in practice may be a coating of suitable density and composition. Instead of liquid or chemical vapor deposition, however, the present approach uses a pressurized fluid to deliver the coating chemistry and facilitate high density coating on the surfaces of the fibers. In a preferred embodiment of the invention, supercritical carbon dioxide is used as a solvent and is thus environmentally benign.

The use of a pressurized coating transport has many advantages. High pressure increases reaction kinetics, allowing for fiber weave to be coated in bulk. Several proposed coating solutions to date that address CAF involve coating the fiber before it is woven into a mesh, thus requiring the coated fiber to be subject to several additional cleaning and mechanical steps, adding to cost and degrading the coating quality. Moreover, supercritical CO₂ acts as an excellent cleaner, thus a separate cleaning operation is not necessarily required.

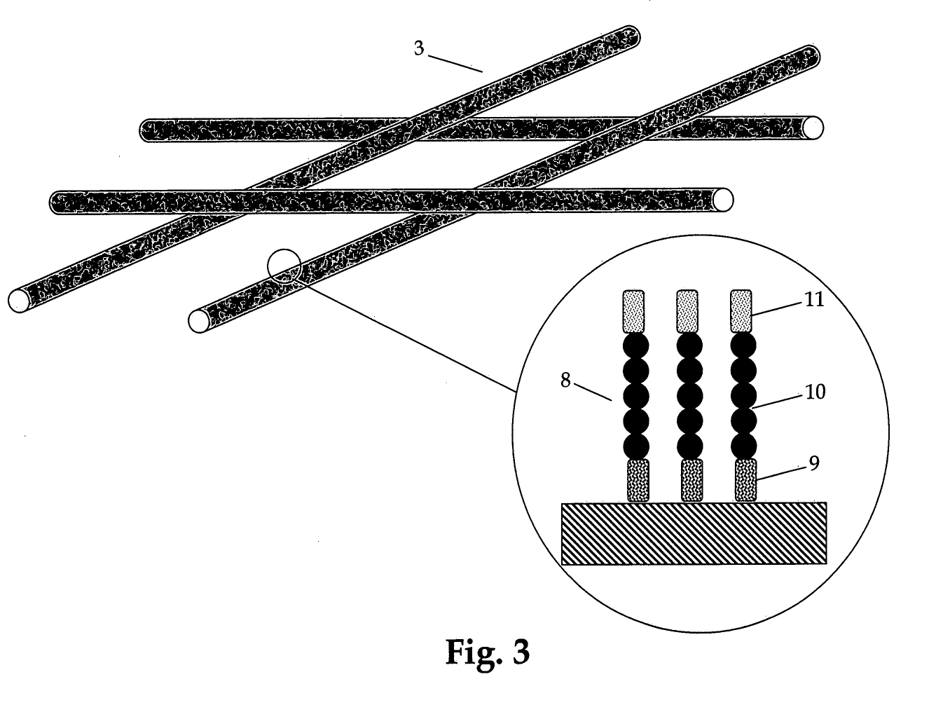

FIG. 3 illustrates the result of the invention. A coating material is formed from a particular type of molecule. Typically these molecules 8 have two functional ends 9 and 11 separated by a spacer 10. The spacer is usually a chain of carbon atoms 10. One end is chosen such that it, in possible combination with enabling chemical agents, preferentially bonds with the filament surface. The other end is designed for specific functionality. Two functionalities are particularly suited to improving resistance to CAF.

One functionality is achieved by designing functional end 11 such that end 11 bonds more strongly to the resin matrix than the bare fiber or commercially available coatings. Some examples of suitable molecules to treat fibers which are compatible with a pressure delivered coating process are shown in Table 2

TABLE 2
Chemistry Treatments

N-(2-AMINOETHYL)-3-AMINOPROPYLTRIMETHOXYSILANE
3-AMINOPROPYLTRIETHOXYSILANE
TRIMETHOXYSILYLPROPYLDIETHYLENETRIAMINE
3-GLYCIDOXYPROPYLTRIMETHOXYSILANE
2-(3,4-EPOXYCYCLOHEXYL)ETHYLTRIMETHOXYSILANE
3-CHLOROPROPYLTRIMETHOXYSILANE
3-MERCAPTOPROPYLMETHYLDIMETHOXYSILANE
3-MERCAPTOPROPYLTRIMETHOXYSILANE
3-METHACRYLOXYPROPYLTRIMETHOXYSILANE
3-MERCAPTOPROPYLTRIETHOXYSILANE
3-ISOCYANATOPROPYLTRIETHOXYSILANE
3-AMINOPROPYLTRIMETHOXYSILANE
n-PHENYLAMINOPROPYLTRIMETHOXYSILANE
VINYLTRIS(METHYLETHYLKETOXIME)SILANE
n-OCTYLTRICHLOROSILANE
n-OCTYLTRIMETHOXYSILANE

A stronger bond will result in less interface separation under temperature stress, leading to decreased opportunity for CAF. Another functionality is if end 11 is hydrophobic, thus not allowing for moisture in the vicinity of the filament and therefore not providing a medium for CAF to occur. The treatments in Table 2 all will increase bond strength, and all will to some extent resist wetting by water. Two coatings that result in hydrophobic surfaces in Table 2 are n-OCTYLTRIMETHOXYSILANE and 3-METHACRYLOXYPROPYLTRIMETHOXYSILANE. The materials in Table 2 are shown by way of example. Skilled practitioners will recognize many other suitable coatings that can be applied using the invention which will have either bond strengthening, hydrophobic or both effects. Another useful functionality is to design the coating such that it acts as an ion getter, trapping the metal salts that lead to CAF growth. Silane chemistries such as the ones in Table 2 can be made to act as ion getter functional treatments. In all cases a pressurized coating process is particularly advantageous as explained below.

If the coating agent can be made to diffuse evenly over the surface, a single layer of molecules standing up on the surface will form. This process of spontaneous alignment is known as self-assembly, and results in a dense, uniform coating when formed under pressure. This coating, shown in FIG. 3, will strengthen the resin-fiber bond, repel moisture, trap ions or possibly some combination, making the composite more resistant to CAF. However it is important to understand that achieving a fully self-assembled monolayer coating is not necessary to the invention. Traditional fiber coating methods, due to the difficulty of processing the thin fiber filaments, achieve coating densities that are very low compared to those achieved by the invention. Moreover, the coatings achieved in the prior art are not typically well-aligned in terms of the functional ends of the treating molecules. Thus from a practical viewpoint, for example, the inventors have found that an increase of 1.5 nm RMS in surface roughness after coating compared to the fiber native roughness, measured over 85% of any given 100 micron square area, delivers beneficial results. Such a criteria is measurable by standard surface metrology techniques such as XPS or AFM, allowing for process control. Such a coating may not be considered a SAM, but offers similar enough properties to achieve the intended benefits of the invention.

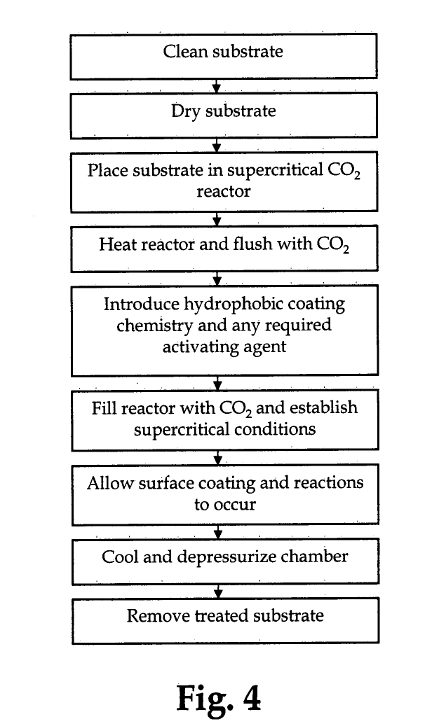

The coating process of the invention is as follows: fiber weave, preferably in bulk to reduce cost and processing time, is introduced into a pressure/thermal reaction chamber, and possibly heated to drive off excess adsorbed water and low-level contamination. (See flow diagram in FIG. 4.) The chamber is flushed with the pressurized agent, which will at least partially dissolve the coating agent. Although the preferred embodiment utilizes the dissolving agent in the supercritical fluid state, as shown in 4, it is possible to use a pressurized fluid, not supercritical, to achieve improved coating. Pressures as low as 30 PSI have shown some beneficial results, and pressures above 860 PSI, where CO₂ liquifies at room temperature are beneficial as well. However there are advantages to being in the supercritical state during the agent removal step of the process, so even if the coating is done non-supercritical, it may still be advantageous to be supercritical at some part of the process. The invention preferentially uses CO₂ as the dissolving agent, but other agents are possible. The chamber is then pressurized with the dissolving agent and possibly heated. The hydrophobic and/or bond strength enhancer chemistry (must be soluble in the pressurized fluid) is added to the chamber in an amount sufficient to allow dense coating coverage on the fiber surfaces. Alternatively, the coating chemistry may be introduced to the chamber prior to pressurization, as indicated in FIG. 4. For the preferred embodiment utilizing supercritical CO₂, pressurization and heating is typically to 1,500 psi and 150° C., in order to establish supercritical conditions and allow the surface reactions to take place. For cases where the coating process achieves SAM formation, bond densities significantly exceed 1.5 molecules/nm² with these process conditions. Increasing the processing pressure, however, can further improve the density of bonding. At 3,000 psi and 150° C., for instance, the bond density can exceed 4.5 molecules/nm². For non-SAM coatings, the density may be lower but still significantly higher than with conventional processes. The above process values have been shown by the inventors to achieve advantageous results due to improved reaction kinetics. The kinetics operating in the supercritical regime are particularly useful for fiber coating, as they result in even surface coating even for fiber in bulk form, as the supercritical fluid will permeate through the bulk weave. Operating at or above the nominal supercritical transition state for CO₂, 1070 PSI and 34.5° C., also yields beneficial results compared to current techniques. The chamber is left at these conditions for a suitable time, typically between 5 and 30 minutes. It is then cooled, depressurized, and the treated fiber is removed from the chamber. The degree of hydrophobicity and/or bonding strength increase with the density and proper molecular orientation of surface coatings, so coatings produced in this way offer a performance advantage over conventional coatings.

Increasing the fiber-resin bond strength decreases the possibility of interface separation around fibers. Making the fibers hydrophobic inhibits the conditions required for CAF, independent of interface separation. Applying these coatings using supercritical processing achieves a much higher coating density than any previous process. Higher density makes for stronger bonding between fiber and resin due to increased number of bonding sites per given area. The inventors believe that supercritical processing is the only practical method to achieve effective hydrophobic or ion getter coatings. Lower densities achieved with other processes may still allow water to diffuse through the relatively sparse coating molecules. The coating densities achieved with supercritical processing offer a much greater barrier to water and/or ion diffusion. Finally the ability to process the fiber for coating in bulk, with no post cleaning is a significant advantage of the current invention. Prior coating techniques require coating the fibers before they are woven into the mesh. The further weaving and cleaning processes remove portions of the coating, making the coating even less effective to prevent CAF.

Another technique applied to processing the composite can further increase resistance to CAF. The resin-fiber interface separation due to exposure to high temperature is caused in part by expansion and contraction of the resin matrix. The resins used in PCB substrates typically have high thermal expansion coefficients, on the order of 15-100 mm/mm/° C. The introduction of low thermal expansion coefficient powder into the resin can, under the proper circumstances, lower the effective thermal expansion coefficient of the resin. This, in turn, reduces interface stresses that promote separation. This is illustrated in FIG. 5 wherein the resin matrix 6 has particles mixed into the resin. Suitable particles which produce this effect are shown in Table 3.

TABLE 3
Particles

SiO₂
TiO₂
Mg(OH)₂
ZnO
BN
Al₂O₃
Typical particle size ranges from 5 nm to 1 micron.

In addition to lowering temperature expansion, other advantageous results can be achieved by mixing particles into the matrix. For instance, particles which serve as ion getters may be mixed, which will cause the resin to trap the metal ions which form the CAF conductive growths. Similarly, hydrophobic or hydrophilic particle to either repel or trap moisture may also be mixed in. Or some combination of the above may be employed. Silica particles, SiO₂ for example, will act to trap moisture.

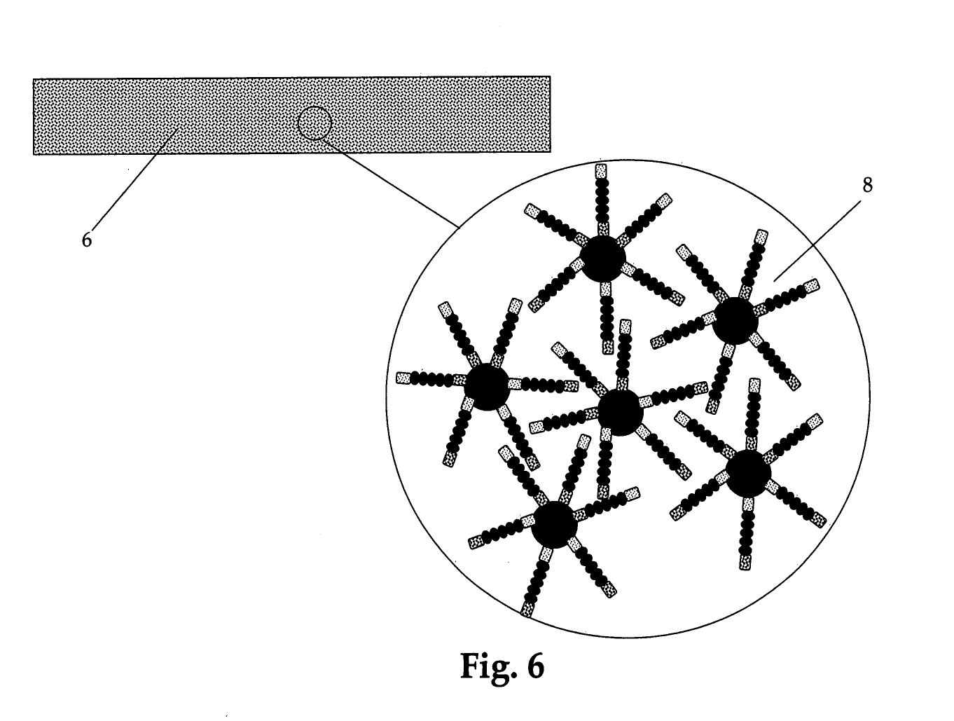

In order to be effective however, the particles mixed in have to bond well with the resin. As shown in FIG. 6, it is advantageous to coat the particles with functional chemistry 8 to promote bonding. Or alternatively, the bonding, ion getter, hydrophobic/hydrophilic properties may be achieved by applying coatings to inert particles, or particles with fewer attributes than desired. The most effective way to coat the surface of powder, which can only be efficiently treated in bulk, is a supercritical coating process as described above. Thus a low thermal expansion coefficient powder may be placed, in bulk, in a reactor as described above and coated with functionalized coating agents. Preferentially, a CAF resistant composite will be produced using both fiber coating and functional in-resin particles as described herein, although use of any single or combination of the processes will improve CAF resistance. It is also advantageous to provide a particle coating that aids in dispersal and mixing of the particles into the resin. The chemistries in Table 2 again serve as an example partial list of coating agents which will be effective as particle coatings.

Described below are examples of actual embodiments of the invention.

### EXAMPLE 1

### 7628 Weave with 2 Silanes +Filler

In one preferred embodiment, both the glass reinforcement of the printed circuit board and a resin filler are treated with a chemical treatment. Heat cleaned 7628 glass cloth is used in the present example, and is placed into a reaction chamber and treated simultaneously with two different silane compounds. The glass cloth remains wound on a mandrel, which can weigh hundreds of pounds and measure up to five feet in width and tens of inches in diameter. The reduction in handling associated with this process minimizes fiber damage and improves the final performance of the cloth.

Once the bolt of cloth is loaded and the reaction chamber is sealed, CO₂ is pumped into the chamber until a pressure of 2,000 psi is reached. The chamber is simultaneously heated to a temperature of 110° C. The CO₂ is circulated within the chamber using a high-shear paddle fitted with a Magnedrive™ coupling. At these conditions the CO₂ is a supercritical fluid and acts to clean the surface of the fibers, liberating residual oils and carbonaceous material remaining from the heat cleaning process. The cleaning effect ensures that a maximum number of bonding sites will be available on the glass fibers, creating a final composite with superior properties. The pressure in the chamber is then lowered to 100 psi, flushing dissolved contaminates from the chamber and cloth. The contaminates are subsequently held in a series of traps that scrub the CO₂ as it leaves the chamber.

The chamber is then re-pressurized to 2,500 psi and heated to 110° C. Once these conditions are reached, two silane compounds are injected into the reaction chamber using separate syringe pumps. (In general, several combinations of silane compounds can be used, and premixed if desired.) In the present embodiment, the silanes are selected for compatibility with an epoxy-based resin. Glycidoxypropyltrimethoxysilane and aminopropyltrimethoxysilane are added simultaneously to obtain a surface of 60 and 40%, respectively. The amount of silane employed depends on the surface area of the fiber cloth to be treated. The reaction chamber is mixed as the reactants are added to the chamber.

Once the reactants are added, the pressure and temperature are increased to 3,000 psi and 150° C. These conditions are held for 10 minutes while mixing the supercritical CO₂. The chamber is then vented to atmosphere and the treated cloth is removed.

The resin filler consists of equal mixtures of TiO₂ and SiO₂ particles with a nominal diameter of 30 nm. The mass of each material treated varies from 1 kg to 50 kg, but depending on throughput requirements the amount of filler can greatly exceed these values. Treatment of the TiO₂ involves placing the material in a reaction chamber and pressurizing with CO₂ until 2,000 psi. The chamber is simultaneously heated to a temperature of 110° C. The CO₂ and filler are circulated within the chamber using a specially designed container that is internally rotated via connection with a Magnedrive™ coupling. At these conditions the CO₂ is a supercritical fluid and acts to clean the surface of the particles, liberating residual oils and carbonaceous material remaining from the heat cleaning process. The cleaning effect ensures that a maximum number of bonding sites will be available, enabling good dispersion and interface strength in the final composite. The pressure in the chamber is then lowered to atmospheric pressure, flushing dissolved contaminates from the chamber and cloth. The contaminates are subsequently held in a series of traps that scrub the CO₂ as it leaves the chamber.

At this stage, depending on the original condition of the particles, nitrogen gas saturated with water is flowed through the reaction chamber to hydrate the particle surface. This is typically done for three minutes as the chamber is mixed to ensure a particle surface condition that is ideal for SAM deposition. Following this, the chamber is pressurized with CO₂ to 100 psi and flushed to atmosphere.

The chamber is then re-pressurized to 2,500 psi with CO₂ and heated to 110° C. Once these conditions are reached, glycidoxypropyltrimethoxysilane is injected into the reaction chamber using a syringe pump. (In general, several combinations of silane compounds can be used, and premixed if desired.) In the present embodiment, the silane is selected for compatibility with an epoxy-based resin. The amount of silane employed depends on the surface area of the filler to be treated. The reaction chamber is mixed as the reactants are added to the chamber at a rate.

Once the reactants are added, the pressure and temperature are increased to 3,000 psi and 150° C. These conditions are held for 10 minutes while mixing the supercritical CO₂ and filler. The chamber is then vented to atmosphere and the treated filler is removed.

The SiO₂ treatment is done in the same manner, and mixed with the TiO₂ filler. The fillers are mixed with an epoxy resin to a total volume fraction of 10%. The treatment of the particles ensures good dispersion and wetting with the resin. The treated 7628 cloth is then impregnated with the filled epoxy resin using standard techniques.

### EXAMPLE 2

### 1080 Weave with 2 Silanes

In one preferred embodiment, heat cleaned 1080 glass cloth is placed into a reaction chamber and treated simultaneously with two different silane compounds. The glass cloth remains wound on a mandrel, which can weigh hundreds of pounds and measure up to five feet in width and tens of inches in diameter. The reduction in handling associated with this process minimizes fiber damage and improves the final performance of the cloth.

Once the bolt of cloth is loaded and the reaction chamber is sealed, CO₂ is pumped into the chamber until a pressure of 2,000 psi is reached. The chamber is simultaneously heated to a temperature of 110° C. The CO₂ is circulated within the chamber using a high-shear paddle fitted with a Magnedrive™ coupling. At these conditions the CO₂ is a supercritical fluid and acts to clean the surface of the fibers, liberating residual oils and carbonaceous material remaining from the heat cleaning process. The cleaning effect ensures that a maximum number of bonding sites will be available on the glass fibers, creating a final composite with superior properties. The pressure in the chamber is then lowered to 100 psi, flushing dissolved contaminates from the chamber and cloth. The contaminates are subsequently held in a series of traps that scrub the CO₂ as it leaves the chamber.

The chamber is then re-pressurized to 2,500 psi and heated to 110° C. Once these conditions are reached, two silane compounds are injected into the reaction chamber using separate syringe pumps. (In general, several combinations of silane compounds can be used, and premixed if desired.) In the present embodiment, the silanes are selected for compatibility with an epoxy-based resin. Glycidoxypropyltrimethoxysilane and aminopropyltrimethoxysilane are added simultaneously to obtain a surface of 60 and 40%, respectively. The amount of silane employed depends on the surface area of the fiber cloth to be treated. The reaction chamber is mixed as the reactants are added to the chamber at a rate.

Once the reactants are added, the pressure and temperature are increased to 3,000 psi and 150° C. These conditions are held for 10 minutes while mixing the supercritical CO₂. The chamber is then vented to atmosphere and the treated cloth is removed.

### EXAMPLE 3

### 106 Weave with Beta-(3,4-Epoxyccyclohexyl)ethyltrimethoxysilane

In another preferred embodiment, heat cleaned 106 glass cloth is placed into a reaction chamber and treated with Beta-(3,4-Epoxyccyclohexyl)ethyltrimethoxysilane. The glass cloth remains wound on a mandrel as in example 1. The reduction in handling associated with this process minimizes fiber damage and improves the final performance of the cloth.

The chamber is then pressurized to 2,000 psi and heated to 120° C. Once these conditions are reached, the Beta-(3,4-Epoxyccyclohexyl)ethyltrimethoxysilane is injected into the reaction chamber using a syringe pump. This type of surface treatment can be used with expoxy, urethane and acrylic resins. The amount of silane employed depends on the surface area of the fiber cloth to be treated. The reaction chamber is mixed as the reactants are added to the chamber.

Once the reactants are added, the pressure and temperature are increased to 3,000 psi and 150° C. These conditions are held for 10 minutes while mixing the supercritical CO₂. The chamber is then vented to atmosphere and the treated cloth is removed.

### EXAMPLE 4

### 1652 Weave with Aminopropyltrimethoxysilane

In another preferred embodiment, heat cleaned 1652 glass cloth is placed into a reaction chamber and treated with aminopropyltrimethoxysilane. The chamber is then pressurized to 2,000 psi and heated to 120° C. Once these conditions are reached, the aminopropyltrimethoxysilane is injected into the reaction chamber using a syringe pump. The amount of silane employed depends on the surface area of the fiber cloth to be treated. The reaction chamber is mixed as the reactants are added to the chamber.

Once the reactants are added, the pressure and temperature are increased to 2,500 psi and 135° C. These conditions are held for 10 minutes while mixing the supercritical CO₂. The chamber is then vented to atmosphere and the treated cloth is removed.

### EXAMPLE 5

### 1080 Weave with methacryloxyprQpyltrimethoxysilane

In another preferred embodiment, heat cleaned 1652 glass cloth is placed into a reaction chamber and treated with methacryloxypropyltrimethoxysilane. The chamber is then pressurized to 2,500 psi and heated to 110° C. Once these conditions are reached, the methacryloxypropyltrimethoxysilane is injected into the reaction chamber using a syringe pump. The amount of silane employed depends on the surface area of the fiber cloth to be treated. The reaction chamber is mixed as the reactants are added to the chamber.

Once the reactants are added, the pressure and temperature are increased to 4,000 psi and 165° C. These conditions are held for 5 minutes while mixing the supercritical CO₂. The chamber is then vented to atmosphere and the treated cloth is removed.

The above described embodiments are not intended to limit the scope of the present invention, as one skilled in the art can, in view of the present disclosure, expand such embodiments to correspond with the subject matter of the invention claimed below.

I claim:

1. A process for treating a fiber, comprising;
placing the fiber in a reactor,
pressurizing the reactor,
introducing at least a first agent into the reactor,
introducing a second coating agent, and any required activating agents, into the reactor, the coating agent chosen to be both solvent in the pressurized first agent, and have chemical properties such that when exposed to the fiber surface will form a coating; and,
leaving the agents and fiber in the reactor under pressurized conditions for a time sufficient to coat the fiber surface with a coating layer, the coating agent having been constructed to have chemical properties including at least one of;
the coating layer will create a bond with the resin that increases resin-fiber bond reliability in the completed composite under exposure to elevated temperatures,
the coating layer will act as an ion getter,
the coating layer will be hydrophobic.

2. The process of claim 1 further comprising the step of heating the reactor.

3. The process of claim 1 wherein the fiber has been woven into a mesh before being placed in the chamber.

4. The process of claim 1 wherein the reactor is pressurized to a pressure ≧860 PSI.

5. The process of claim 1 wherein the reactor is pressurized to a pressure ≧1070 PSI.

6. The process of claim 1 wherein the reactor is pressurized to a pressure ≧1500 PSI.

7. The process of claim 1 wherein the reactor is pressurized to a pressure ≧3000 PSI.

8. The process of claim 3 wherein the woven fiber is on a mandrel when placed in the chamber.

9. The process of claim 2 wherein the heating and pressurization levels are set for at least some time period such that the first agent is a supercritical fluid.

10. The process of claim 9 wherein the first agent is CO₂, and the pressure is ≧1070 PSI and the temperature is ≧34.5° C.

11. The process of claim 9 wherein the first agent is CO₂, and the pressure is ≧1500 PSI and the temperature is ≧150° C.

12. The process of claim 9 wherein the first agent is CO₂, and the pressure is ≧3000 PSI and the temperature is ≧150° C.

13. The process of claim 1 where the coating is a SAM and the coating density is ≧1.5 molecules/nm².

14. The process of claim 1 where the coating is a SAM and the density is ≧4.5 molecules/nm².

15. The process of claim 1 wherein the coating agent may be chosen from a list which includes;
N-(2-AMINOETHYL)-3-AMINOPROPYLTRIMETHOXYSILANE
3-AMINOPROPYLTRIETHOXYSILANE
TRIMETHOXYSILYLPROPYLDIETHYLENETRIAMINE
3-GLYCIDOXYPROPYLTRIMETHOXYSILANE
2-(3,4-EPOXYCYCLOHEXYL)ETHYLTRIMETHOXYSILANE
3-CHLOROPROPYLTRIMETHOXYSILANE
3-MERCAPTOPROPYLMETHYLDIMETHOXYSILANE
3-MERCAPTOPROPYLTRIMETHOXYSILANE
3-METHACRYLOXYPROPYLTRIMETHOXYSILANE
3-MERCAPTOPROPYLTRIETHOXYSILANE
3-ISOCYANATOPROPYLTRIETHOXYSILANE
3-AMINOPROPYLTRIMETHOXYSILANE
n-PHENYLAMINOPROPYLTRIMETHOXYSILANE
VINYLTRIS(METHYLETHYLKETOXIME)SILANE
n-OCTYLTRICHLOROSILANE
n-OCTYLTRIMETHOXYSILANE.

16. The process of claim 1 wherein the coating produces an increase in surface roughness relative to the native filament roughness of at least 1.5 nm RMS over 85% of any 100 micron square area.

17. A process for treating a resin intended to be a component of a resin-fiber composite, comprising mixing particles in with the resin before making the composite, wherein the particles are chosen or treated to have properties including at least one of;
a lower thermal expansion coefficient than the resin,
increased bond strength with the fibers that increases resin-fiber bond reliability in the completed composite under exposure to elevated temperatures,
act as an ion getter,
be hydrophobic, or
be hydrophillic.

18. The process of claim 17 wherein the particles include compounds chosen from the list of;
SiO₂
TiO₂
Mg(OH)₂
ZnO
BN
Al₂O₃.

19. The process of claim 17 wherein the particles are in the size range of 5 nm to 1 micron

20. The process of claim 17, including steps for treating the particles, comprising;
placing the particles in a reactor,
introducing a first agent into the reactor,
pressurizing the reactor,
introducing a second coating agent, and any required activating agents, into the reactor, the second agent chosen to be both solvent in the pressurized first agent, and have chemical properties such that when exposed to the particle surface will coat the particle surface and,
leaving the agents and particles in the reactor under pressurized conditions for a time sufficient to coat the particles' surface with a dense coating layer of the coating agent, the coating agent having been constructed to have chemical properties including at least one of;
the coating layer will create a bond between the particles and the resin and/or aid in dispersal of the particles when mixed with the resin
the coating layer will create a bond with the fibers that increases resin-fiber bond reliability in the completed composite under exposure to elevated temperatures,
the coating layer will act as an ion getter,
the coating layer will be hydrophobic, or
the coating layer will be hydrophillic.

21. The process of claim 20 further comprising the step of heating the reactor.

22. The process of claim 20 wherein the reactor is pressurized to a pressure ≧860 PSI.

23. The process of claim 20 wherein the reactor is pressurized to a pressure ≧1070 PSI.

24. The process of claim 20 wherein the reactor is pressurized to a pressure ≧1500 PSI.

25. The process of claim 20 wherein the reactor is pressurized to a pressure ≧3000 PSI.

26. The process of claim 21 wherein the heating and pressurization levels are set for at least some time period such that the first agent is a supercritical fluid.

27. The process of claim 26 wherein the first agent is CO₂, and the pressure is ≧1070 PSI and the temperature is ≧34.5° C.

28. The process of claim 26 wherein the first agent is CO₂, and the pressure is ≧1500 PSI and the temperature is ≧150° C.

29. The process of claim 26 wherein the first agent is CO₂, and the pressure is ≧3000 PSI and the temperature is ≧150° C.

30. The process of claim 20 where the coating is a SAM and the coating density is ≧1.5 molecules/nm².

31. The process of claim 20 where the coating is a SAM and the density is ≧4.5 molecules/nm².
